(19) United States
(12) Patent Application Publication
(10) Pub. No.: US 2003/0139217 A1
(43) Pub. Date: Jul. 24, 2003

(54) Shaft damper

(76) Inventors: Lin Zhu, Rochester Hills, MI (US); Yahya Hodjat, Oxford, MI (US); Marc R. Cadarette, London (CA)

Correspondence Address: Jeffrey Thurnau, The Gates Corporation, Mail Stop 31-4-1-A3, 900 S. Broadway, Denver, CO, 80209, US

(21) Appl. No.: 10/057,028

(22) Filed: Jan. 23, 2002

(51) Int. Cl. F16C 3/00

(52) U.S. Cl. 464/180

(57) ABSTRACT

The invention comprises a shaft damper having an inertial mass engaged with an elastomeric member within a shaft bore. The elastomeric member is contained in an annular space between a shaft inner surface and an outer surface of the inertial mass. A profile on the outer surface of the inertial mass enhances a mechanical bond with the elastomeric member. The elastomeric member and the inertial mass are disposed in the shaft in order to damp a bending vibration of the shaft.

### FIELD OF THE INVENTION

The invention relates to a shaft damper, and more particularly, to a shaft damper comprising an elastomeric member and inertial mass contained within a shaft bore at a predetermined location.

### BACKGROUND OF THE INVENTION

Rotating shafts generally oscillate in various modes depending on the type of service. Shaft vibrations contribute to noise. Dampers are known which damp shaft vibrations. The dampers reduce operating noise as well as premature wear of the shaft and failure of the shaft by fatigue.

Dampers may take the form of a flexible liner in a drive shaft. They also may comprise a torsional damper comprising an inertial mass within an annular chamber fixed to a shaft outer surface.

Representative of the art is U.S. Pat. No. 5,749,269 (1998) to Szymanski et al. which discloses a viscous torsional vibration damper having an annular chamber surrounding a central hub. Inertial masses are contained within the annular chamber.

Also representative of the art is U.S. Pat. No. 4,909,361 (1990) to Stark et al. which discloses a vibration damper for the hollow drive shaft of an automobile vehicle having a liner press fitted into the bore of the drive shaft and a resilient, deformable, elastic, highly frictional retaining strip, which forcibly bears against the surface of the bore and fixes the liner in place within the shaft.

The prior art dampers either comprise only a liner press fit into a drive shaft, or, they comprise inertial masses attached to a shaft outer surface. These present problems with respect to operational space as well as damping coefficient. Further, they are primarily directed toward torsional damping with little effect as to damping a bending vibration along a shaft length.

What is needed is a shaft damper for damping a bending vibration. What is needed is a shaft damper comprising an inertial mass engaged with an elastomeric member within a shaft bore at a predetermined location. The present invention meets these needs.

### SUMMARY OF THE INVENTION

The primary aspect of the invention is to provide a shaft damper for damping a bending vibration.

Another aspect of the invention is to provide a shaft damper comprising an inertial mass engaged with an elastomeric member within a shaft bore at a predetermined location.

Other aspects of the invention will be pointed out or made obvious by the following description of the invention and the accompanying drawings.

The invention comprises a shaft damper having an inertial mass engaged with an elastomeric member within a shaft bore. The elastomeric member is contained in an annular space between a shaft inner surface and an outer surface of the inertial mass. A curved profile on an outer profile of the inertial mass enhances a mechanical bond with the elastomeric member. The elastomeric member and the inertial mass are disposed in the shaft in a predetermined location in order to damp a bending vibration of the shaft.

### BRIEF DESCRIPTION OF THE DRAWINGS

FIG. 1 is a cross-sectional side view of the inventive shaft damper.

FIG. 2 is a detail of the inventive shaft damper.

FIG. 3 is a detail of a grooved inertial member surface.

### DETAILED DESCRIPTION OF THE INVENTION

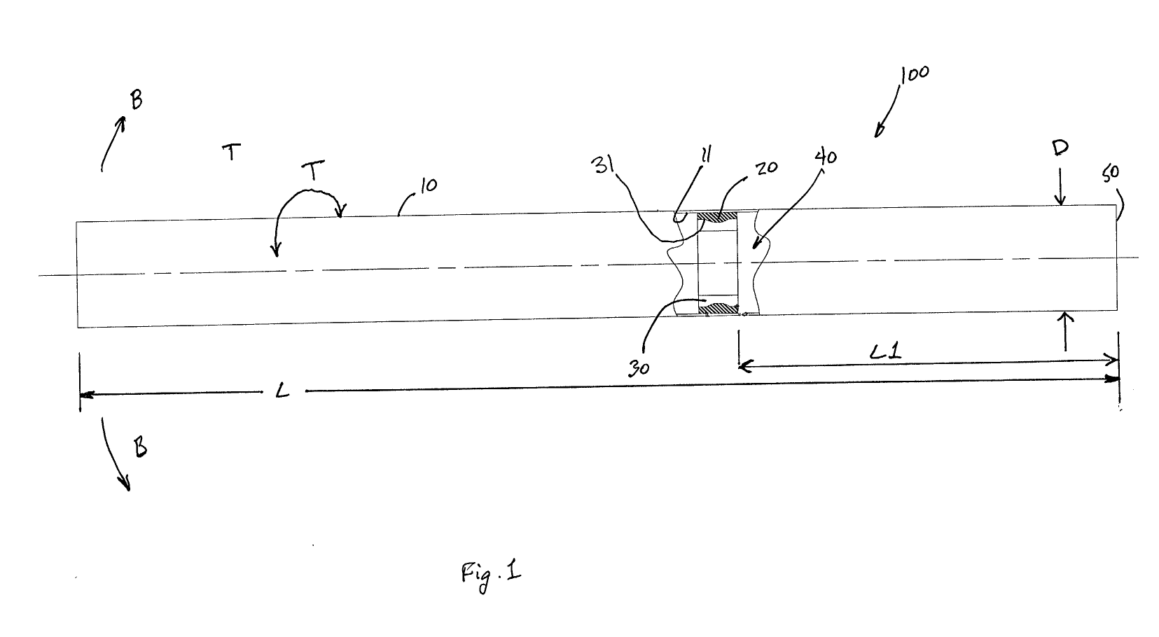

FIG. 1 is a cross-sectional side view of the inventive shaft damper. Shaft damper 100 comprises shaft body 10 and bore 40. Shaft 10 having a length L and a diameter D. Elastomeric member 20 is engaged between shaft body 10 and inertial member 30 in bore 40. Elastomeric member 20 and inertial member 30 are located at distance L1 from an end 50 of shaft 10.

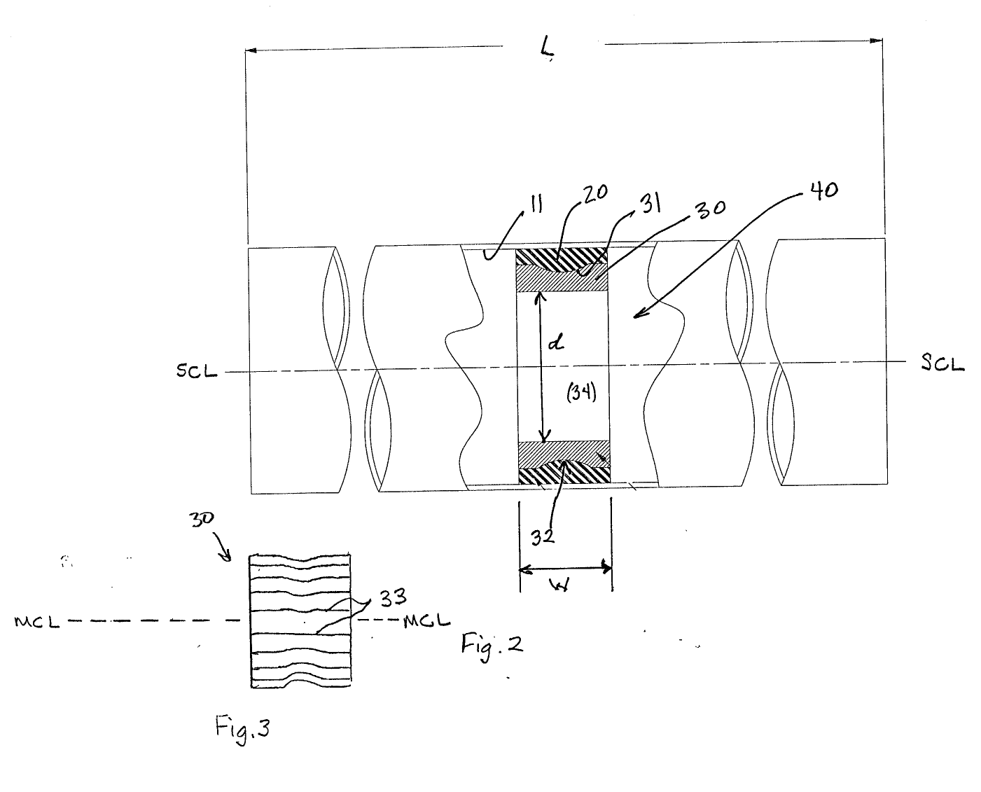

FIG. 2 is a detail of the inventive shaft damper. Elastomeric member 20 is engaged between a shaft body inner surface 11 and an inertial member outer surface 31. Inner surface 11 may comprise a surface roughness to enhance a surface coefficient of friction.

Elastomeric member 20 is compressed in a range of 5% to 50% between the inner surface 11 and the outer surface 31. Inertial member 30 further comprises relief surface 32 in outer surface 31 which serves to mechanically engage inertial member 30 to elastomeric member 20. This will properly retain the elastomeric member in a proper position (retention usually measured by a push out test or torque-to-turn), without increasing the overall stiffness.

Relief surface 32 may comprise any suitable geometric shape as may be required to properly fix a position of the inertial member in bore 40. An arcuate shape for surface 32 is depicted in FIG. 2. A surface roughness to increase a coefficient of friction may also be applied to surface 32 to fix a position of inertial member in bore 40.

Elastomeric member 20 comprises a resilient material that may comprise any natural rubber, synthetic rubber, any combination or equivalent thereof, or any other resilient material that is capable of withstanding a shaft operating temperature. Although the following is not intended as a limiting list, a resilience, static shear, dynamic shear, compression modulus and flex fatigue of the resilient member may each be selected to give a desired damping effect.

An elastomer stiffness can be adjusted by adjusting a profile of the curved shape of the surface 32. In this manner a shaft damping can be designed to damp a particular operating frequency. The position L1 of damper 100 in a shaft length L is adjustable to damp a predetermined shaft vibration mode. The present invention can be tuned for damping torsional vibration T as well as a bending vibration B, see FIG. 1. This is accomplished by adjusting the elastomer torsional and bending stiffness to attenuate shaft torsional and bending vibrations. Further, two or more dampers may be used in a shaft in different locations in order to damp selected shaft torsional and bending vibration modes.

The advantages of the inventive damper over the prior art are readily apparent since one or more of the inventive dampers can be placed at any position along the length of a shaft in order to provide such damping as may be required. Further the damper is contained entirely within a shaft, thereby eliminating the possibility of mechanical damage or failure during operation. Reduction of a shaft bending and torsional vibration will reduce fatigue related failures, thereby extending a shaft life.

Further, a shape of surface 32, a mass of inertial member 30, and the physical dimensions of the inertia member 30 are each variable and selected to accommodate specific shaft frequency and mode damping requirements. Inertial member comprises a width W. Central bore 34 extending through inertial member 30 has a diameter d.

In an alternate embodiment inertial member 30 does not have a central bore 34 thereby comprising a solid body. This allows a user to maximize an inertial member mass to accommodate a vibration parameter.

The inertia and frequency of the damper are calculated based on the system modal mass, natural frequency of the shaft and the engine vibration caused by cylinder firing. The inertial member may comprise any metallic or nonmetallic material, or equivalents thereof suitable for an engine operating condition.

An elastomer stiffness can be adjusted by changing the shape of the elastomer member. By changing an elastomer stiffness, one can adjust a frequency to be damped by the damper. It can also be adjusted by changing an elastomer compression between the shaft and the inertial mass in a range from approximately 5% to 50% of an uncompressed thickness.

Assembly of the inventive shaft damper simply comprises pressing the elastomeric member with the inertial member into the shaft.

FIG. 3 is a detail of a grooved inertial member surface. In another embodiment, the inertial mass comprises a profile having grooves 33 extending parallel to a shaft centerline SCL, or extending parallel to an inertial mass centerline MCL. This creates mechanical locking between the inertial mass 30 and the elastomeric member 20 in a radial direction.

One skilled in the art can appreciate that the present invention is much more adjustable as to an inertial member location in a shaft and compact in length than prior art dampers. It is also far simpler in design and simpler in construction.

Although a form of the invention has been described herein, it will be obvious to those skilled in the art that variations may be made in the construction and relation of parts without departing from the spirit and scope of the invention described herein.

I claim:

1. A shaft comprising:
an outer member having an inner surface describing a bore;
an inertial member disposed within the bore and having an outer surface; and
a resilient member compressed between the outer member inner surface and the inertial member outer surface for damping a shaft vibration.

2. The shaft as in claim 1 further comprising:
a relief in the inertial member outer surface for mechanically engaging the resilient member.

3. The shaft as in claim 2, wherein the resilient member is compressed in a range of 5% to 50% of an uncompressed thickness between the inner surface and the outer surface.

4. The shaft as in claim 2, wherein the inertial member damps a bending vibration.

5. The shaft as in claim 1, wherein the inertial member further comprises a groove extending parallel to a shaft centerline.

6. The shaft as in claim 1 further comprising;
a plurality of inertial members engaged with a plurality of resilient members.

7. A shaft damper comprising:
an inertial member having an outer surface;
a resilient member engaged with the outer surface; and
the resilient member having a resilient member outer surface for engaging a shaft bore surface.

8. The shaft damper as in claim 7 further comprising:
a profile in the inertial member outer surface for mechanically engaging the resilient member.

9. The shaft damper as in claim 7, wherein the inertial member profile further comprises a groove extending parallel to an inertial mass centerline.
